(19) United States
(12) Patent Application Publication
(10) Pub. No.: US 2010/0304275 A1
(43) Pub. Date: Dec. 2, 2010

(54) CHANNEL MODULE AND FUEL CELL

(75) Inventors: Ching-Po Lee, Hsinchu County (TW); Cheng Wang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: YOUNG GREEN ENERGY CO., Hsinchu County (TW)

(21) Appl. No.: 12/613,500

(22) Filed: Nov. 5, 2009

(30) Foreign Application Priority Data
May 26, 2009 (TW) 98117459

(51) Int. Cl. H01M 2/00

(52) U.S. Cl. 429/515

(57) ABSTRACT

A channel module suitable to diverge or converge a liquid fuel includes a first carrier, a second carrier, and a cover. The first carrier has a channel opening and a channel communicating with the channel opening. The second carrier disposed on the first carrier has at least one accommodation cavity and at least one main opening. The main opening is located at the geometry center of a bottom surface of the accommodation cavity and the accommodation cavity communicates with the channel through the main opening. The cover disposed on the second carrier has a plurality of sub-openings. The sub-openings communicate with the accommodation cavity, the locations of the sub-openings are on a same plane and form a geometry shape, and the orthogonally projected location on the plane of the main opening is the geometry center of the geometry shape. A fuel cell employing the channel module is also provided.

### CROSS-REFERENCE TO RELATED APPLICATION

This application claims the priority benefit of Taiwan application serial no. 98117459, filed May 26, 2009. The entirety of the above-mentioned patent application is hereby incorporated by reference herein and made a part of specification.

### BACKGROUND OF THE INVENTION

1. Field of the Invention

The invention relates to a channel module and a fuel cell using the channel module for diverging or converging a liquid fuel.

2. Description of Related Art

The development and application of energy is always an indispensable condition for the human lives. However, how to conduct the development and application of energy without destroying our environment is an important project for us. The energy produced by means of the fuel cell technology is advantageous in high efficiency, low noise, and pollution-free. Therefore, the fuel cell becomes an energy mean meeting the modern time trend. The usual fuel cell today includes proton exchange membrane fuel cell (PEMFC) or direct methanol fuel cell (DMFC).

In order to realize larger watts with a fuel cell, the fuel cell employs a plurality of fuel modules to generate electricity, wherein the liquid fuel stored in a mixing unit is driven by a driving unit (for example, a pump) and is evenly transformed to every fuel module through a flow-diverging module so that the fuel modules are fed by the liquid fuel to generate electricity. Further, the liquid fuel after the chemical reaction and the gas produced by the chemical reaction are expelled by a flow-converging module. Based on the description above, the right channel design of the flow-diverging module and the flow-converging module are critical to affect the stability of generating electricity of the fuel modules.

### SUMMARY OF THE INVENTION

Accordingly, the invention is directed to a channel module able to evenly diverge or smoothly converge a liquid fuel.

The invention is also directed to a fuel cell employing a channel module able to evenly diverge or smoothly converge a liquid fuel.

Other advantages of the invention may be further indicated by the disclosures of the invention, and omitted herein for simplicity.

To achieve one of, a part of or all of the above-mentioned advantages, or to achieve other advantages, an embodiment of the invention provides a channel module. The channel module is suitable to diverge or converge a liquid fuel. The channel module includes a first carrier, a second carrier, and a cover. The first carrier has a channel opening and a channel, wherein the channel opening communicates with the channel. The second carrier is disposed on the first carrier and has at least one accommodation cavity and at least one main opening, wherein the main opening is located at the geometry center of a bottom surface of the accommodation cavity and the accommodation cavity communicates with the channel through the main opening. The cover is disposed on the second carrier and has a plurality of sub-openings, wherein the sub-openings communicate with the accommodation cavity, the locations of the sub-openings are on a same plane and form a geometry shape, and the orthogonally projected location on the plane of the main opening is the geometry center of the geometry shape.

Another embodiment of the invention provides a fuel cell. The fuel cell includes a plurality of fuel modules, a first channel module, a mixing unit, and a second channel module. The first channel module is suitable to diverge a liquid fuel to the fuel modules. The second channel module is suitable to converge the liquid fuel from the fuel modules to the mixing unit. The first channel module and the second channel module respectively include a first carrier, a second carrier, and a cover. The first carrier has a channel opening and a channel, wherein the channel opening communicates with the channel. The second carrier is disposed on the first carrier and has at least one accommodation cavity and at least one main opening, wherein the main opening is located at the geometry center of a bottom surface of the accommodation cavity and the accommodation cavity communicates with the channel through the main opening. The cover is disposed on the second carrier and has a plurality of sub-openings, wherein the sub-openings communicate with the accommodation cavity, the locations of the sub-openings are on a same plane and form a geometry shape, and the orthogonally projected location on the plane of the main opening is the geometry center of the geometry shape. The liquid fuel is capable of entering the channel opening of the first channel module and is capable of being respectively transferred to the fuel modules through the sub-openings of the first channel module. The liquid fuel come from the fuel modules is capable of entering the sub-openings of the second channel module and then is capable of being transferred to the mixing unit through the channel opening of the second channel module.

In an embodiment of the invention, the fuel cell further includes a supplying unit for supplying the liquid fuel into the mixing unit. In an embodiment of the invention, the fuel cell further includes a driving unit suitable to transfer the liquid fuel of the mixing unit to the first channel module.

In an embodiment of the invention, the bottom surface of the accommodation cavity is an arc surface.

In an embodiment of the invention, the channel is a Y-shaped channel.

In an embodiment of the invention, the cover further includes a protrusive portion, the protrusive portion is located in the accommodation cavity, an accommodation space is located between the protrusive portion and the accommodation cavity, the sub-openings are through the protrusive portion and communicate with the accommodation space, and the accommodation space communicates with the channel through the main opening. In an embodiment of the invention, the shape of the protrusive portion is similar to the shape of the accommodation cavity. In an embodiment of invention, the cover further includes a plurality of locking elements and the locking elements are located at a side of the cover far away from the second carrier so as to respectively lock the fuel modules.

In an embodiment of the invention, the second carrier further includes a plurality of sub-channels, the sub-channels are located at the bottom surface of the accommodation cavity and communicate with the main opening. The sub-channels respectively extend to the sub-openings from the main opening as a radial center, and each of the sub-openings communicates with the main opening through the corresponding sub-channel.

In an embodiment of the invention, the second carrier further includes a buffer concave portion, the buffer concave portion takes the main opening as the center and communicates with the sub-channels, and the maximum sectional area of the buffer concave portion is substantially equal to 0.8-1.2 times as large as the sum of the sectional areas of all the sub-openings. In an embodiment of the invention, the sum of the sectional areas of all the sub-openings is substantially equal to the maximum sectional area of the buffer concave portion.

The embodiment or the embodiments of the invention may have at least one the following advantages. The bottom surface of the accommodation cavity of the channel module is designed into an arc surface and the main opening is located at the geometry center of the bottom surface of the accommodation cavity, so that the bubbles in the channel module may be successfully expelled, so as to avoid piling the bubbles and avoid the velocity of flow during converging the liquid fuel from being affected by the pilled bubbles. In addition, since the orthogonal projection of the main opening is located at the geometry center of the geometry shape formed by the sub-openings, therefore, during diverging the liquid fuel, the liquid fuel may be evenly provided to each of the fuel modules, so as to make the generated electric power of each of the fuel modules connecting the channel module more even. In short, the fuel cell employing the above-mentioned channel module may provide a stable electric power.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an exploded view of a channel module according to the first embodiment of the invention.

FIG. 1B is an exploded view of the channel module of FIG. 1A in another angle of view.

FIG. 1C is a cross-sectional view of the cover of FIG. 1A with the cover disposed on the second carrier.

FIG. 2A is an exploded view of a channel module according to another embodiment of the invention.

FIG. 2B is an exploded view of the channel module of FIG. 2A in another angle of view.

FIG. 3 is a diagram of a fuel cell according to further another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

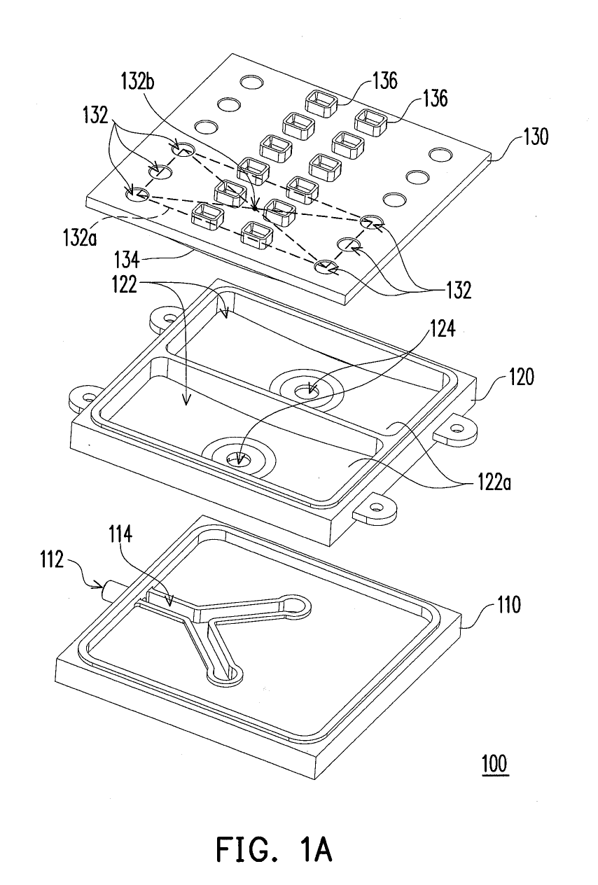

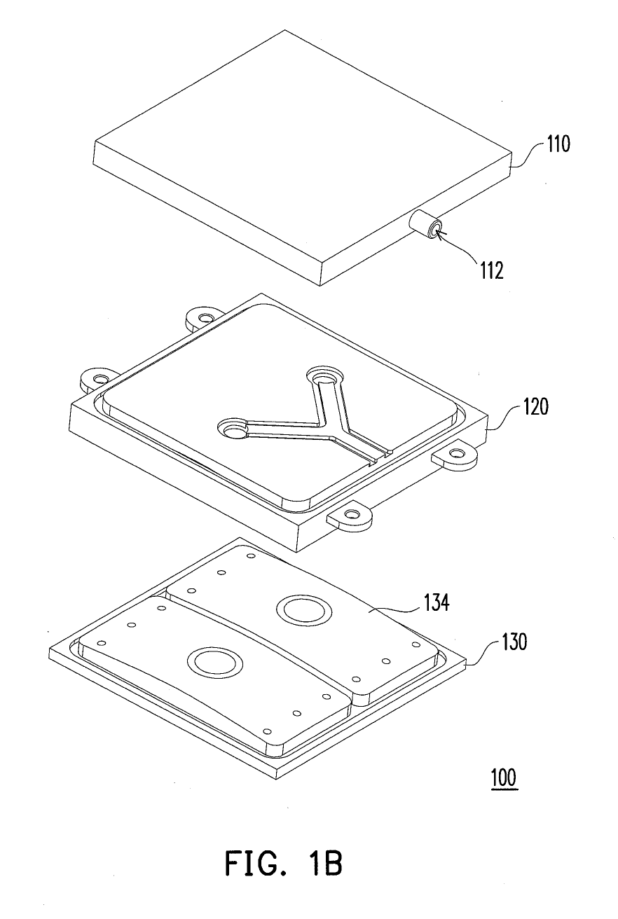

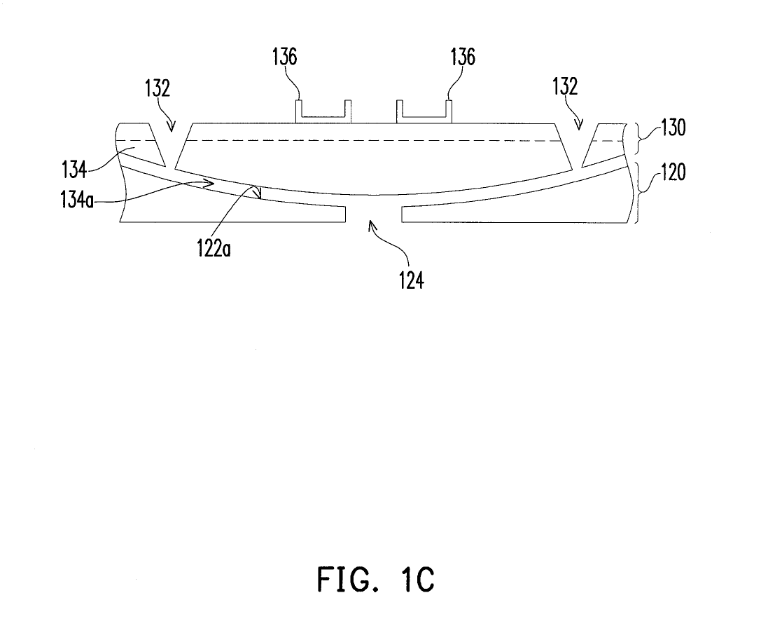

Referring to FIGS. 1A and 1B, a channel module 100 of an embodiment is suitable to diverge or converge a liquid fuel, and the channel module 100 includes a first carrier 110, a second carrier 120, and a cover 130.

The first carrier 110 has a channel opening 112 and a channel 114, wherein the channel opening 112 communicates with the channel 114. In the embodiment, when the channel module 100 is used to diverge the liquid fuel, the channel opening 112 serves as an inlet, so that the liquid fuel enters the first carrier 110 from the channel opening 112, and then is transferred to the second carrier 120 through the channel 114. In another embodiment, when the channel module 100 is used to converge the liquid fuel, the channel opening 112 serves as an outlet, so that the liquid fuel come from the second carrier 120 is transferred to the first carrier 110, and then is discharged from the channel opening 112 through the channel 114.

In the embodiment, the channel 114 may be a Y-shaped channel with one-to-two design as shown in FIG. 1A; however in other unshown embodiments, the channel 114 may be a channel with one-to-multiple design depending on the requirement of the user. In addition, in another feasible embodiment, the channel 114 may be, for example, a channel with one-to-one design (i.e. with a bar-shape) depending on the requirement of the user. The invention is not limited to the above mentioned.

In the channel module 100, the second carrier 120 is disposed on the first carrier 110 and has at least one accommodation cavity 122 and at least one main opening 124, wherein the main opening 124 is located at the geometry center of a bottom surface 122a of the accommodation cavity 122, and the accommodation cavity 122 communicates with the channel 114 through the main opening 124.

In the embodiment, since the channel 114 is designed into a Y-shaped channel, the second carrier 120 accordingly has two accommodation cavities 122 and two main openings 124 so that the channel 114 of the first carrier 110 may communicate with the accommodation cavities 122 of the second carrier 120 through the main openings 124. In the embodiment, the numbers of the accommodation cavity 122 and the main opening 124 may be one or a plurality according to the design of the channel 114, but the embodiments exemplarily targets two accommodation cavities 122 and two main openings 124. The invention is not limited to the above mentioned.

When the channel module 100 is used to diverge the liquid fuel, the liquid fuel come from the channel 114 is transferred into the accommodation cavities 122 from the channel 114 through the main openings 124 of the second carrier 120, wherein the bottom surface 122a of each of the accommodation cavities 122 may be an arc surface, as shown in FIG. 1A or 1C. Similarly, when the channel module 100 is used to converge the liquid fuel, the liquid fuel come from the cover 130 is transferred into the accommodation cavities 122 of the second carrier 120, and then is transferred to the first carrier 110 through the main openings 124 communicating with the channel 114 of the first carrier 110.

In the embodiment, the bottom surface 122a of each of the accommodation cavities 122 is designed into an arc surface so as to adapt the situation that when the channel module 100 is used to converge the liquid fuel, there may be a part of gas or bubbles produced during transferring the liquid fuel, and the arc bottom surface 122a of the accommodation cavity 122 may easily expel out the gas along with the arc surface from the main opening 124. As a result, the main opening 124 may be unlikely clogged or obstructed by the gas (or bubbles) and the velocity of flow during converging the liquid fuel may be not affected by the gas (or bubbles). Accordingly, the fuel cell employing the channel module keeps the good electric performance during generating electricity.

In the channel module 100, the cover 130 is disposed on the second carrier 120 and has a plurality of sub-openings 132, wherein the sub-openings 132 communicate with the accommodation cavities 122, as shown by FIG. 1C. The locations of the sub-openings 132 are on a same plane and form a geometry shape 132a, and the orthogonally projected location on the plane of the main opening 124 is the geometry center 132b of the geometry shape 132a, as shown by FIG. 1A.

In other words, when the channel module 100 is used to diverge the liquid fuel, the liquid fuel come from the second carrier 120 may be respectively transferred to the sub-openings 132 of the cover 130 from the main openings 124 with an evenly distributed flux and the liquid fuel diverged in the sub-openings 132 may evenly flow with a velocity of flow. As a result, when a plurality of fuel modules (not shown) are respectively connected to each of the sub-openings 132, each of the fuel modules during generating electricity has a better and even electric performance, wherein due to the above-mentioned structure design, the liquid volume of the liquid fuel transferred in each of the fuel modules and the velocity of flow thereof are almost the same as each other so that the fuel modules during generating electricity respectively have almost the same electric performance without generating uneven generated electric power.

In the embodiment, the cover 130 further includes a protrusive portion 134, and when the cover 130 is disposed at the second carrier 120, the protrusive portion 134 is located in the accommodation cavity 122, wherein an accommodation space 134a is located between the protrusive portion 134 and the accommodation cavity 122 to make the liquid fuel flow between the protrusive portion 134 and the accommodation cavity 122, as shown in FIG. 1C. The shape of the protrusive portion 134 may be similar to that of the accommodation cavity 122.

The sub-openings 132 are through the protrusive portion 134 to communicate with the accommodation space 134a, and the accommodation space 134a communicates with the channel 114 through the main openings 124. When the channel module 100 is used to diverge or converge the liquid fuel, the liquid fuel may be transferred between the cover 130 and the second carrier 120 by means of the above-mentioned communication way. Moreover, a better performance of the liquid fuel during transferring may be achieved by designing the protrusive portion 134 with an appropriate shape and an appropriate volume. For example, an appropriate volume of the accommodation space 134a enables the liquid fuel come from the main opening 124 to be quickly transferred to the sub-openings 132, respectively. On the other hand, if the volume of the accommodation space 134a is excessive, the liquid fuel may be slowly transferred to the sub-openings 132.

In the embodiment, the cover 130 further includes a plurality of locking elements 136, wherein the locking elements 136 are located at a side of the cover 130 far away from the second carrier 120, as shown in FIG. 1A. The locking elements 136 may respectively lock the plurality of fuel modules 310 to make the intake opening (unshown) or the discharge opening (unshown) of each of the fuel modules communicate with a corresponding sub-opening 132. In this way, the liquid fuel may be diverged into each of the fuel modules by the channel module 100 or all the liquid fuel come from each of the fuel modules may be converged into the channel module 100 and then expelled out from the channel opening 112.

In short, the channel module 100 of the embodiment is designed in this way that the bottom surface 122a of the accommodation cavity 122 is an arc surface and the main opening 124 is located at the geometry center of the bottom surface 122a of the accommodation cavity 122, so that the bubbles in the channel module 100 may be effectively expelled out and the problem of an excessive flow resistance caused by piling the bubbles may be avoided, which result in a better velocity of flow during diverging or converging the liquid fuel. In addition, since the orthogonal projection of the main opening 124 is located at the geometry center 132b of the geometry shape 132a formed by the sub-openings 132, the channel module 100 may more evenly diverge the liquid fuel to the plurality of fuel modules and such that the generated electric power of each of the fuel modules is more even.

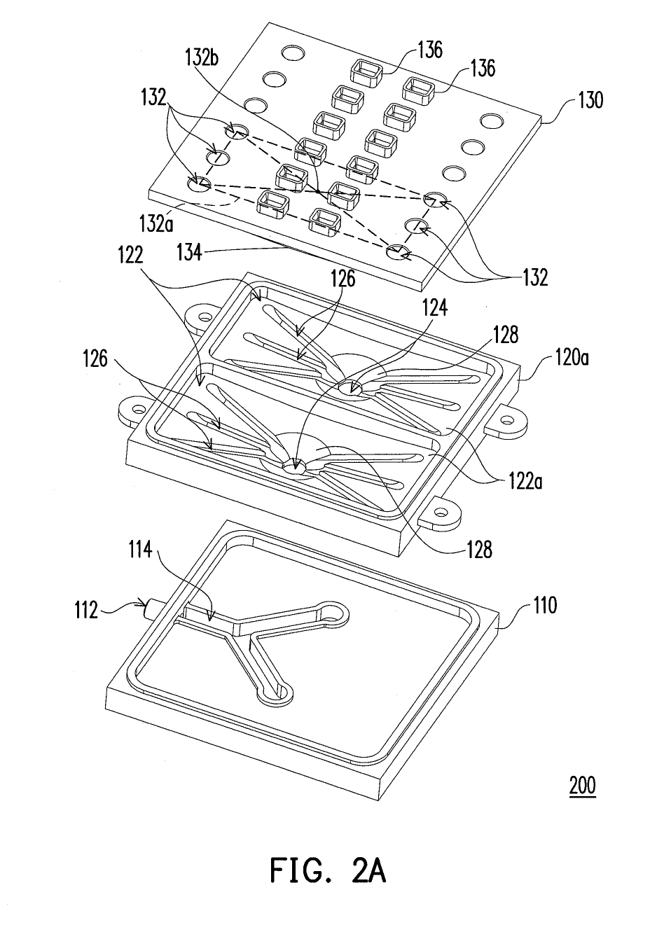

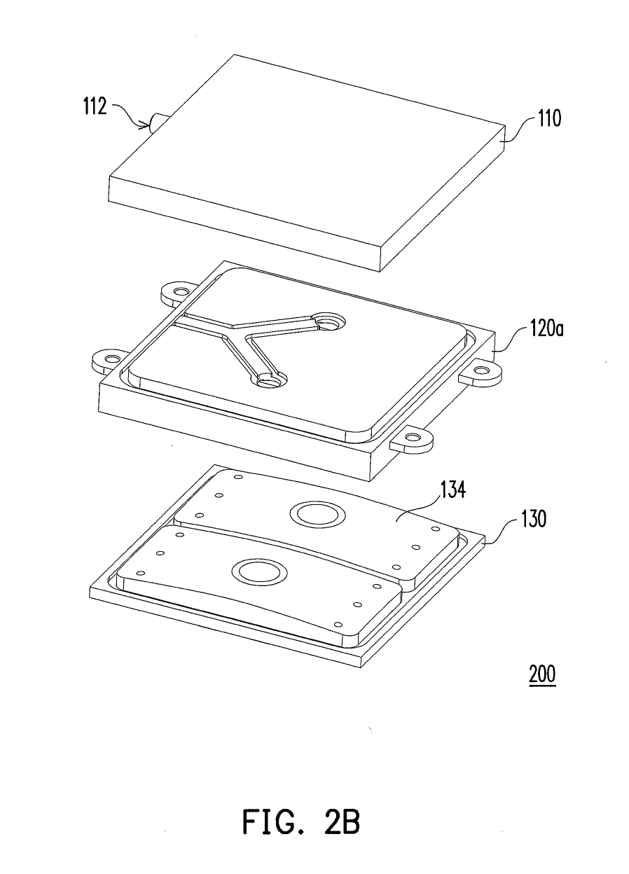

Referring to FIGS. 1A, 1B, 2A and 2B, the channel module 200 of the embodiment has a structure similar to that of the channel module 100 of the previous embodiment except that the second carrier 120a in this embodiment further has a plurality of sub-channels 126 as shown in FIG. 2A.

In the embodiment, the sub-channels 126 are located on the bottom surface 122a of the accommodation cavity 122 and communicate with the main opening 124. In addition, the sub-channels 126 respectively extend to the sub-openings 132 from the main opening 124 as a radial center, so that each of the sub-openings 132 communicates with the main opening 124 through a corresponding sub-channel 126. In this way, when the channel module 200 is used to diverge or converge the liquid fuel, the liquid fuel may be transferred among the first carrier 110, the second carrier 120a, and the cover 130 through the above-mentioned communication structure.

The second carrier 120a further includes a buffer concave portion 128 as shown in FIG. 2A. In the embodiment, the buffer concave portion 128 takes the main opening 124 as a center and communicate with the sub-channels 126 from the center. In the embodiment, the maximum sectional area parallel to the sub-openings 132 of the buffer concave portion 128 is substantially equal to 0.8-1.2 times as large as the sum of the sectional areas of all the sub-openings 132. Generally, the buffer concave portion 128 mainly functions to avoid a rapid change of flow resistance during a large flux of the liquid fuel is dispersed into many small fluxes (for example, when the liquid fuel flows from the main opening into each of the sub-channels). Besides, the buffer concave portion 128 is also used for adjusting the action of the gas in the channel module 200 on the diverging process conducted by the channel module 200 (for example, adjusting the velocity of flow in each channel to be more even as each other). In more details, the buffer concave portion 128 is used to effectively expel out the gas in the channel module 200, so that the gas bubbles are unlikely piled and the velocity of flow during diverging or converging is less affected by the gas bubbles. In an embodiment, the sum of the sectional areas of all the sub-channels 126 is substantially equal to the maximum sectional area parallel to the sub-openings 132 of the buffer concave portion 128, and the sectional areas of each of the sub-channels 126 is substantially equal to the quotient of the maximum sectional area parallel to the sub-openings 132 of the buffer concave portion 128 divided by the number of the sub-channels 126.

In the channel module 200 when the second carrier 120a is disposed at the first carrier 110 and the cover 130 is disposed at the second carrier 120a, the accommodation space 134a between the protrusive portion 134 and the accommodation cavity 122 may be small, i.e., the protrusive portion 134 is close to the accommodation cavity 122, even the protrusive portion 134 totally fits the accommodation cavity 122. In the situation, the liquid fuel is diverged or converged among the first carrier 110, the second carrier 120a, and the cover 130 mainly through the communications among the sub-openings 132, the sub-channels 126 and the main opening 124.

Since the channel module 200 of the embodiment is similar to the channel module 100, the channel module 200 has all the advantages of the channel module 100 above mentioned, and these advantages are omitted to describe. Since the channel module 200 further has the sub-channels 126 and the buffer concave portion 128, in terms of solving the problem caused by the bubbles in the channel module 200, the channel module 200 of the embodiment has better performance. For example, the channel module 200 of the embodiment may easily expel out the bubbles therein to avoid uneven velocity of flow caused by piling the bubbles.

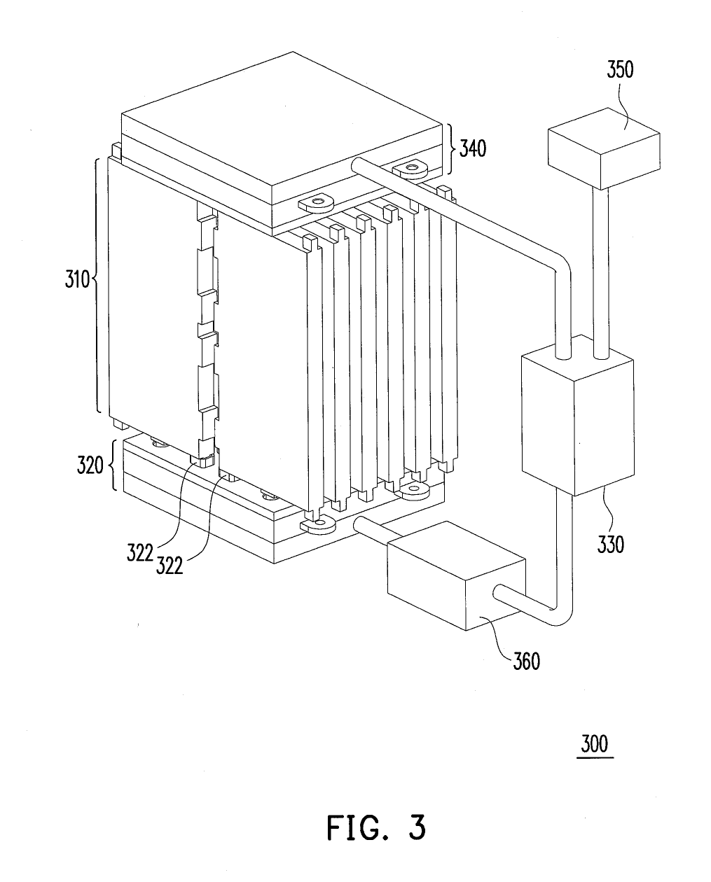

Referring to FIG. 3, a fuel cell 300 of the embodiment includes a plurality of fuel modules 310, a first channel module 320, a mixing unit 330, and a second channel module 340. The first channel module 320 is suitable to diverge a liquid fuel into the fuel modules 310. The second channel module 340 is suitable to converge the liquid fuel come from the fuel modules 310 to the mixing unit 330. In the embodiment, each of the fuel modules 310 is, for example, a methanol fuel module, and the fuel modules 310 are respectively locked by a plurality of locking elements 322 of the first channel module 320 and the second channel module 340.

In the embodiment, the first channel module 320 and the second channel module 340 may have the same designs as the channel module 100 or 200 in the above-mentioned two embodiments, so that the first channel module 320 may evenly and quickly transfer the liquid fuel to each of the fuel modules 310. The fuel modules 310 utilize the liquid fuel for generating electricity, wherein the liquid volume of the fed liquid fuel in each of the fuel modules 310 is even as each other, so that each of the fuel modules 310 may provide almost the same generated electric power and the fuel cell thereby provides a quite stable power.

Besides, the liquid fuel after the chemical reaction in the above-mentioned fuel modules 310 is respectively converged into the second channel module 340, wherein during conducting the chemical reaction for generating electricity by the fuel modules 310, gas, for example, carbon dioxide gas, is produced, so that the liquid fuel transferred into the second channel module 340 contains the carbon dioxide gas bubbles. However, the second channel module 340 has the same structure as the above-mentioned channel module 100 or 200, so that the bubbles may be easily expelled out and the velocity of flow during the converging is not affected by pilling the bubbles.

In the embodiment, the fuel cell 300 further includes a supplying unit 350, as shown in FIG. 3. Generally, the supplying unit 350 is mainly used to supply the liquid fuel into the mixing unit 330 so that the liquid fuel in the mixing unit 330 keeps the concentration within a certain range.

In addition, the fuel cell 300 further includes a driving unit 360, as shown in FIG. 3. The driving unit 360 in the embodiment is suitable to transfer the liquid fuel of the mixing unit 330 to the first channel module 320, wherein the driving unit 360 is, for example, a pump.

Since the first channel module 320 and the second channel module 340 of the fuel cell 300 in the embodiment have the same designs as the channel module 100 or 200 in the above-mentioned two embodiments, and accordingly have the same advantages of the channel module 100 or 200 above mentioned, so that the fuel cell 300 during generating electricity has better performance, wherein the above-mentioned advantages of the channel module 100 or 200 are omitted to describe.

In summary, the embodiment or the embodiments of the invention may have at least one the following advantages. First, the bottom surface of the accommodation cavity is designed into an arc surface and the main opening is located at the geometry center of the bottom surface of the accommodation cavity, so as to benefit to easily expel out the bubbles from the channel module and avoid piling the bubbles to affect the velocity of flow during diverging or converging the liquid fuel. Next, the second carrier with the sub-channels and the buffer concave portion are advantageous to avoid a rapid change of flow resistance during a large flux of the liquid fuel being changed into many small fluxes and to more easily expel out the bubbles. Moreover, since the orthogonal projection of the main opening is located at the geometry center of the geometry shape formed by the sub-openings, the liquid fuel may be evenly diverged into the plurality of fuel modules and the generated electric power of each of the fuel modules may more even as each other. In other words, the fuel cell employing the above-mentioned channel module may provide a more stable generated electric power during generating electricity.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A channel module, suitable to diverge or converge a liquid fuel, the channel module comprising:
a first carrier having a channel opening and a channel, wherein the channel opening communicates with the channel;
a second carrier disposed on the first carrier, the second carrier having at least one accommodation cavity and at least one main opening, wherein the main opening is located at the geometry center of a bottom surface of the accommodation cavity and the accommodation cavity communicates with the channel through the main opening; and
a cover disposed on the second carrier and having a plurality of sub-openings, wherein the sub-openings communicate with the accommodation cavity, the locations of the sub-openings are on a same plane and form a geometry shape, and the orthogonally projected location on the plane of the main opening is the geometry center of the geometry shape.

2. The channel module as claimed in claim 1, wherein the bottom surface of the accommodation cavity is an arc surface.

3. The channel module as claimed in claim 1, wherein the channel is a Y-shaped channel.

4. The channel module as claimed in claim 1, wherein the cover further comprises a protrusive portion, the protrusive portion is located in the accommodation cavity, an accommodation space is located between the protrusive portion and the accommodation cavity, the sub-openings are through the protrusive portion and communicate with the accommodation space, and the accommodation space communicates with the channel through the main opening.

5. The channel module as claimed in claim 4, wherein the shape of the protrusive portion is similar to the shape of the accommodation cavity.

6. The channel module as claimed in claim 1, wherein the second carrier further comprises a plurality of sub-channels, the sub-channels are located at the bottom surface of the accommodation cavity and communicates with the main opening, the sub-channels respectively extend to the sub-openings from the main opening as a radial center, and each of the sub-openings communicates with the main opening through the corresponding sub-channel.

7. The channel module as claimed in claim 6, wherein the second carrier further comprises a buffer concave portion, the buffer concave portion takes the main opening as the center and communicates with the sub-channels, and the maximum sectional area of the buffer concave portion is substantially equal to 0.8-1.2 times as large as the sum of the sectional areas of all the sub-openings.

8. The channel module as claimed in claim 7, wherein the sum of the sectional areas of all the sub-openings is substantially equal to the maximum sectional area of the buffer concave portion.

9. The channel module as claimed in claim 1, wherein the cover further comprises a plurality of locking elements and the locking elements are located at a side of the cover far away from the second carrier.

10. A fuel cell, comprising:
a plurality of fuel modules;
a first channel module suitable to diverge a liquid fuel to the fuel modules;
a mixing unit;
a second channel module suitable to converge the liquid fuel from the fuel modules to the mixing unit, wherein the first channel module and the second channel module respectively comprise:
a first carrier having a channel opening and a channel, wherein the channel opening communicates with the channel;
a second carrier disposed on the first carrier, the second carrier having at least one accommodation cavity and at least one main opening, wherein the main opening is located at the geometry center of a bottom surface of the accommodation cavity and the accommodation cavity communicates with the channel through the main opening; and
a cover disposed on the second carrier and having a plurality of sub-openings, wherein the sub-openings communicate with the accommodation cavity, the locations of the sub-openings are on a same plane and form a geometry shape, and the orthogonally projected location on the plane of the main opening is the geometry center of the geometry shape,
wherein the liquid fuel is capable of entering the channel opening of the first channel module and is capable of being transferred to the fuel modules through the sub-openings of the first channel module, the liquid fuel come from the fuel modules is capable of entering the sub-openings of the second channel module and then is capable of being transferred to the mixing unit through the channel opening of the second channel module.

11. The fuel cell as claimed in claim 10, further comprising a supplying unit for supplying the liquid fuel into the mixing unit.

12. The fuel cell as claimed in claim 10, further comprising a driving unit suitable to transfer the liquid fuel of the mixing unit to the first channel module.

13. The fuel cell as claimed in claim 10, wherein the bottom surface of the accommodation cavity is an arc surface.

14. The fuel cell as claimed in claim 10, wherein the channel is a Y-shaped channel.

15. The fuel cell as claimed in claim 10, wherein the cover further comprises a protrusive portion, the protrusive portion is located in the accommodation cavity, an accommodation space is located between the protrusive portion and the accommodation cavity, the sub-openings are through the protrusive portion and communicate with the accommodation space, and the accommodation space communicates with the channel through the main opening.

16. The fuel cell as claimed in claim 15, wherein the shape of the protrusive portion is similar to the shape of the accommodation cavity.

17. The fuel cell as claimed in claim 10, wherein the second carrier further comprises a plurality of sub-channels, the sub-channels are located at the bottom surface of the accommodation cavity and communicate with the main opening, the sub-channels respectively extend to the sub-openings from the main opening as a radial center, and each of the sub-openings communicates with the main opening through the corresponding sub-channel.

18. The fuel cell as claimed in claim 17, wherein the second carrier further comprises a buffer concave portion, the buffer concave portion takes the main opening as the center and communicates with the sub-channels, and the maximum sectional area of the buffer concave portion is substantially equal to 0.8-1.2 times as large as the sum of the sectional areas of all the sub-openings.

19. The fuel cell as claimed in claim 18, wherein the sum of the sectional areas of all the sub-openings is substantially equal to the maximum sectional area of the buffer concave portion.

20. The fuel cell as claimed in claim 10, wherein the cover further comprises a plurality of locking elements and the locking elements are located at a side of the cover far away from the second carrier so as to respectively lock the fuel modules.
